(19) United States
(12) Patent Application Publication
(10) Pub. No.: US 2004/0128560 A1
(43) Pub. Date: Jul. 1, 2004

(54) Security system preventing computer access upon removal from a controlled area

(76) Inventors: David Carroll Challener, Raleigh, CO (US); Richard Allan Dayan, Wake Forest, NC (US)

Correspondence Address: IBM CORPORATION, PO BOX 12195, DEPT 9CCA, BLDG 002, RESEARCH TRIANGLE PARK, NC, 27709, US

(21) Appl. No.: 10/334,873

(22) Filed: Dec. 31, 2002

(51) Int. Cl. H04L 9/32

(52) U.S. Cl. 713/202; 713/2

(57) ABSTRACT

A control unit transmits an ultrasonic signal having a distinctive characteristic within a controlled area. A protected unit stores two passwords in a non-volatile memory; a Power On Password (POP) and a Privileged Access Password (PAP). If the protected unit is removed from the controlled area, the PAP must be entered in order to re-boot the protected unit. In another embodiment, if the protected unit is removed from the controlled area, either the PAP must be entered in order to re-boot the protected unit, or the protected unit must be returned to the controlled area. Matching “token” generators may be used in both the control unit and the protected unit for added security, and the tokens may be encrypted for additional security.

### BACKGROUND OF THE INVENTION

This invention pertains to computers and other data processing systems and, more particularly, to a security mechanism for preventing access to a computer system that has been removed from a controlled area into which an ultrasonic or other wireless signal is being transmitted.

To discourage theft of computers and the loss or theft of sensitive data stored on the computer, a security system may be used that disables the computer in response to its removal from a controlled area. Special passwords may be required to regain access to a computer that has been disabled in this manner. For example, two types of passwords have been previously used in the personal computer industry; the Power On Password (POP) and the Privileged Access Password (PAP). The user or system administrator is usually given options to enable or disable various features so that the system can be adapted to different levels of security, from a completely insecure system to one that has all available security features enabled.

In one particular configuration, the user is required to enter the POP anytime the system is turned ON. Failure to enter the correct POP will prevent the system from booting the operating system, thereby preventing use of the computer. Conversely, if the user enters the correct POP, the system boots and the user can access the various applications and files stored on the hard drive. However, in this particular configuration, the POP does not permit the user to change the computer's system configuration. To change the system configuration, a PAP must be entered at power ON. If the PAP is known only to the system administrator, the user is prevented from changing the system configuration, which includes the security options of the computer.

Computer security requirements are often set by government agencies. In the United States, the Department of Defense promulgates the Trusted Computer System Evaluation Criteria; DOD 5200.28 STD, 12185, which is generally known as the “Orange Book.” For computer system hardware, the primary requirement is contained in the “Assurance” section, wherein Requirement 6 states:

“Trusted mechanisms must be continuously protected against tampering and/or unauthorized changes . . . ”

As is well known, radio frequency (RF) radiation can penetrate physical boundaries, such as a wall, and the size of a controlled area defined by an RF transmitter depends on the power of the transmitter and the sensitivity of the receiver; not on the physical boundaries of the room in which the transmitter is located. Thus, a controlled area defined by an RF transmitter is generally circular in shape with a radius dependent upon transmitter power and receiver sensitivity. The invention described below, however, provides for a controlled security area having definite boundaries generally defined by the walls of the room in which the control unit is located.

In addition, the control unit of the current invention may transmit various verification and authentication codes so that a protected computer operating in the controlled area can determine if the source of the transmitted signal is authentic and, thus, prevent the protected computer from being operated in an unauthorized area. Using these verification and authentication codes, the system can also re-enable a protected computer system that has been removed from its controlled area and then later returned to the same area; all without requiring the system administrator to enter a Privileged Access Password. The later is particularly useful with portable computers, such as notebook computers, wherein the user may transport the portable computer home in the evening and return the computer to its controlled area the following morning.

### SUMMARY OF THE INVENTION

Briefly, the invention is a data processing system in which a control unit transmits an ultrasonic signal. A protected unit stores two passwords in a non-volatile memory; a Power On Password (POP) and a Privileged Access Password (PAP). The protected unit also includes boot code that is executed when the protected unit is powered ON, and an ultrasonic receiver to receive the signal transmitted by the control unit. If the ultrasonic receiver losses the signal being transmitted by the control unit, a boot password flag in the non-volatile memory is set. The ultrasonic receiver is always ON, such that the boot password flag will always be set upon loss of the ultrasonic signal, even when the protected unit is powered OFF. When the protected system is powered ON, its boot code causes the protected system to check the boot password flag. If the boot password flag is not set, entry of either the POP or PAP will render the protected system operational by permitting the protected system to boot the operating system. If the boot password flag is set, only the entry of the PAP will allow the protected system to boot the operating system.

In another embodiment, the invention is a data processing system in which a control unit includes a wireless transmitter and modulator for transmitting a modulated signal in a controlled area. A token generator in the control unit produces “tokens”, which are pseudo random numbers that change at periodic intervals. The token is used to modulate the signal transmitted by the control unit. A protected unit stores two passwords in a non-volatile memory, a Power On Password (POP) and a Privileged Access Password (PAP), and includes boot code that is executed when the protected unit is powered ON. The protected unit includes a receiver and demodulator to receive and demodulate the signal transmitted by the control unit. The protected unit also includes a token generator that generates the same tokens as the token generator in the control unit. The signal transmitted by the control unit is received by the receiver in the protected unit and demodulated to produce a received token, which is compared to the token generated by the protected unit. If these two tokens are dissimilar, a boot password flag in the non-volatile memory is set. When the protected unit is powered ON, its boot code causes the protected system to check the boot password flag. If the boot password flag has been set, the boot code causes the protected system to compare the current received token to the token generated by protected unit and, if these two tokens match, entry of either the POP or PAP will render the protected system operational by permitting the protected system to boot the operating system. In addition, if these two tokens match, the boot password flag is cleared. If these two tokens are dissimilar, only the entry of the PAP will allow the protected system to boot the operating system. Thus, the need to enter the PAP is avoided in situations wherein the protected unit has been removed from and returned to the controlled area.

In yet another embodiment, the invention is a data processing system in which a control unit includes a wireless transmitter and modulator for transmitting a modulated signal in a controlled area, and a digital signature engine for encrypting and decrypting data. A token generator in the control unit produces “tokens” as described above. The digital signature engine in the control unit encrypts the token using the control unit's private key and the public key belonging to the protected unit. The encrypted token is then used to modulate the signal transmitted by the control unit. A protected unit stores two passwords in a non-volatile memory, a POP and a PAP, and includes boot code that is executed when the protected unit is powered ON. The protected unit includes a receiver, a demodulator and a digital signature engine to receive, demodulate and decrypt the signal transmitted by the control unit. The protected unit also includes a token generator that generates the same tokens as in the control unit. The signal transmitted by the control unit is received by the receiver in the protected unit, demodulated, and decrypted using the protected unit's private key and the control unit's public key to produce a received token. The received token is then compared to the token generated in the protected unit. If these two tokens are dissimilar, a boot password flag in non-volatile memory is set. When the protected unit is powered ON, its boot code causes the protected unit to check the boot password flag. If the boot password flag is set, the boot code causes the protected unit to compare the current received token to the token generated in the protected unit and, if these two tokens are dissimilar or no signal is present, only entry of the PAP will allow the protected system to boot the operating system. However, if these two tokens match, entry of either the POP or PAP will render the protected system operational by permitting the operating system to boot. Thus, the need to enter the PAP is avoided in situations wherein the protected unit has been removed from and returned to the controlled area.

### BRIEF DESCRIPTION OF THE DRAWINGS

FIG. 1 is a perspective view of a computer system embodying the protected unit of the present invention.

FIG. 2 is a perspective view of certain components of the computer system of FIG. 1.

FIG. 3 is a schematic representation of the ceratin security features of a computer system of the present invention.

FIGS. 4A and 4B are pictorial diagrams of two versions of the security system of the present invention.

FIG. 5 is a schematic representation of certain additional security features of a computer system of the present invention.

FIG. 6, which is comprised of FIGS. 6a-6b, is a flow chart of the tamper evident security feature of the present invention.

FIG. 7, which is comprised of FIGS. 7a-7e, is a flow chart of another embodiment of a tamper evident security feature of the present invention.

FIG. 8 is a pictorial diagram of a control point used to define a controlled area of the present invention.

FIG. 9 is a pictorial diagram of a second control point used to define a controlled area of the present invention.

FIG. 10 is a pictorial diagram of a third control point used to define a controlled area of the present invention.

### DESCRIPTION OF THE ILLUSTRATIVE EMBODIMENTS

While the present invention will be described more fully hereinafter with reference to the accompanying drawings in which preferred embodiments of the invention are shown, it is to be understood at the outset of the following description that persons of skill in the appropriate arts may modify the invention described herein while still achieving the favorable results of the invention. Accordingly, the description that follows is to be understood as being a broad teaching directed to persons of skill in the appropriate arts, and not as limiting upon the present invention.

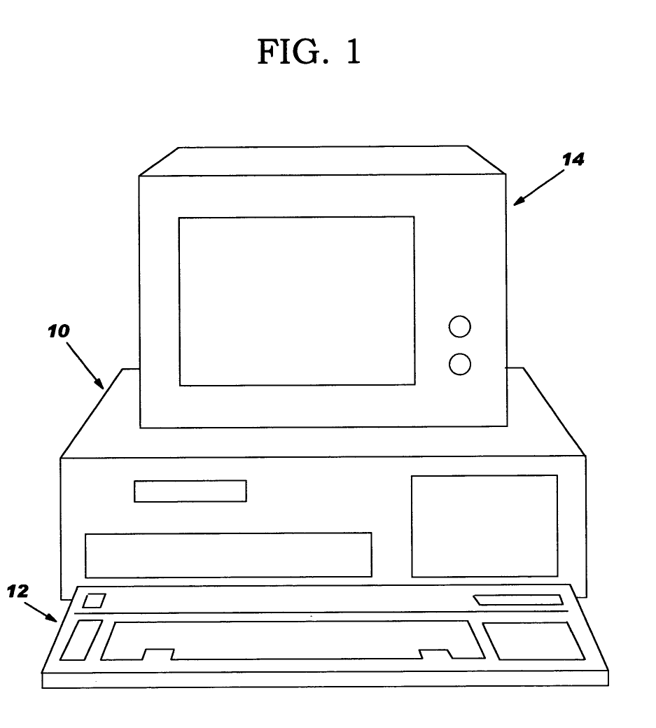

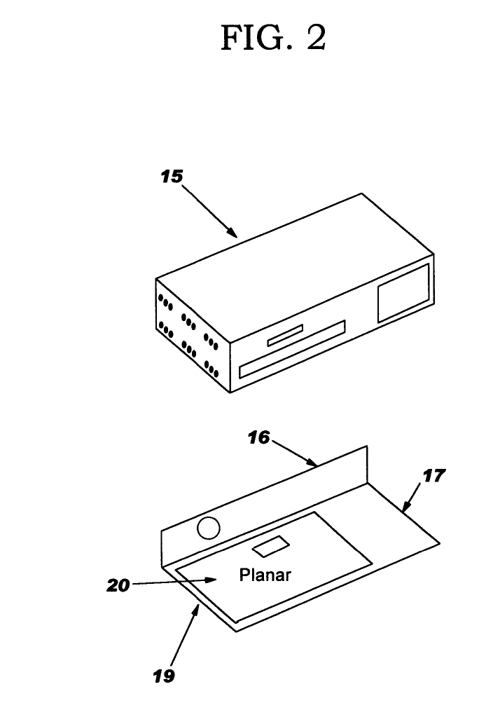

FIG. 1 is a perspective view of a personal computer system 10 embodying the protected unit of the present invention. Referring to this figure, computer system 10 has an associated monitor 14 and keyboard 12. In addition, a printer, plotter and pointing device (not illustrated) may also be attached to computer system 10.

Although a desktop computer system 10 is shown in FIG. 1, it is envisioned that a portable personal computer, such as an IBM Thinkpad® notebook computer, or a personal digital assistance (PDA) may also be utilized to implement the present invention.

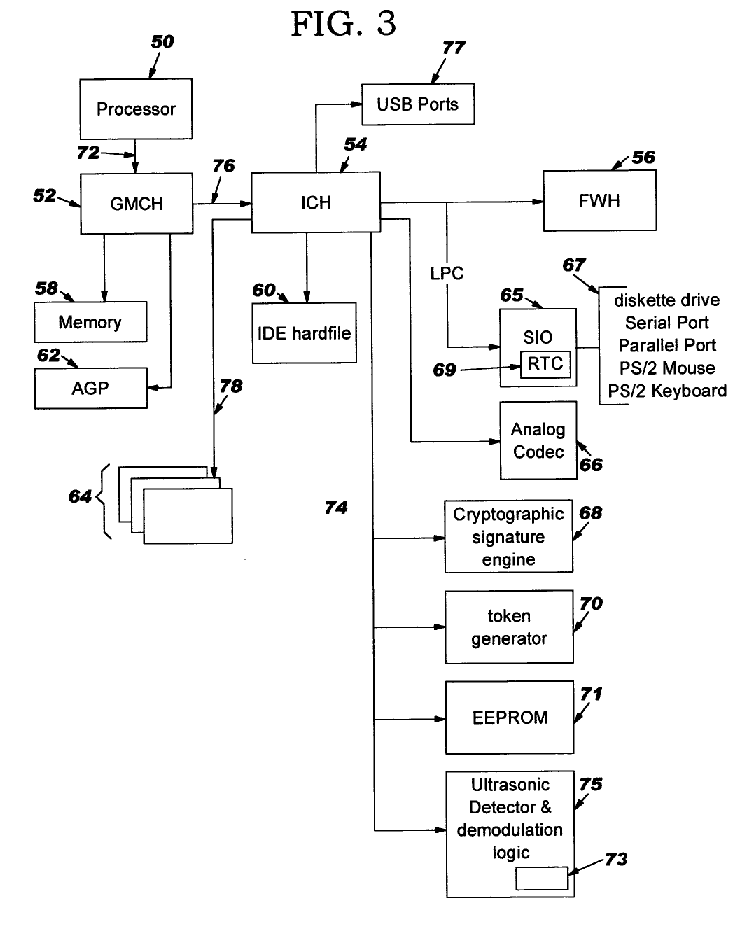

Referring to FIG. 2, a cover 15 cooperates with a chassis 19 in defining an enclosed, shielded volume for receiving data processing and storage components of computer system 10. The front of chassis 19 includes a well known open bay and disk drive (not illustrated). Some of the computer system's components are mounted on planar 20, which is a multi-layer, printed circuit board (also commonly called a “motherboard” or “system board”). Planar 20 is mounted on chassis 19 and provides a means for mounting and electrically interconnecting various components of computer system 10, including a processor or “CPU” 50, system memory 58, and accessory cards or boards 64 (see FIG. 3).

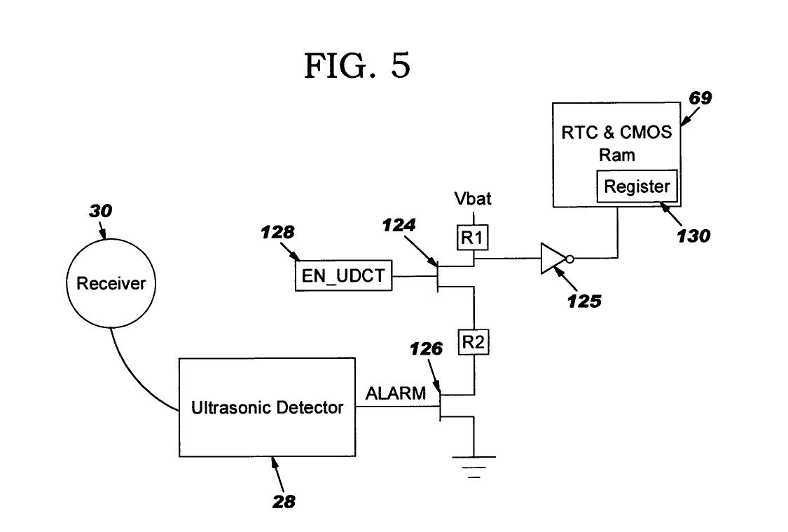

Chassis 19 includes a base 17 and a rear panel 16. At rear panel 16 or another suitable area, according to one aspect of the invention, an ultrasonic receiver 30 (for example, a microphone) is mounted to extend outside computer 10 to receive ultrasound signals (see FIG. 5). Receiver 30 is intended to provide a signal indicating the presence of ultrasound signals in the vicinity of computer system 10 and is connected to a detector 28. Detector 28 is designed to detect the absence of a particular ultrasonic signal with a distinct characteristic, such as a predefined frequency within an ultrasonic frequency band.

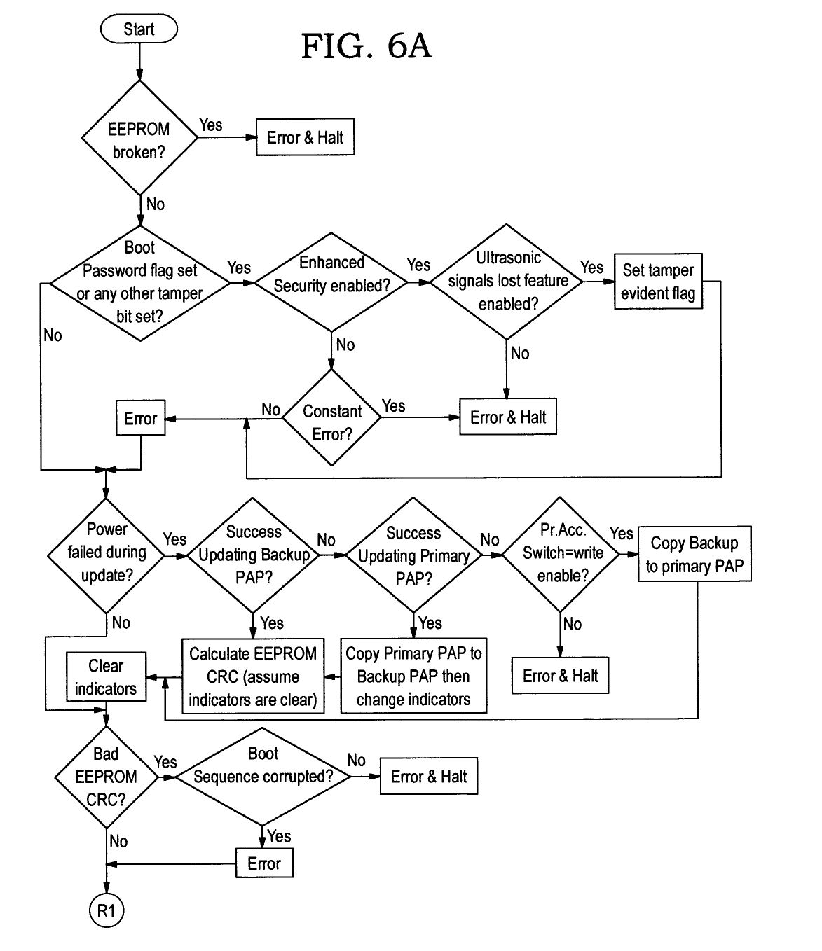

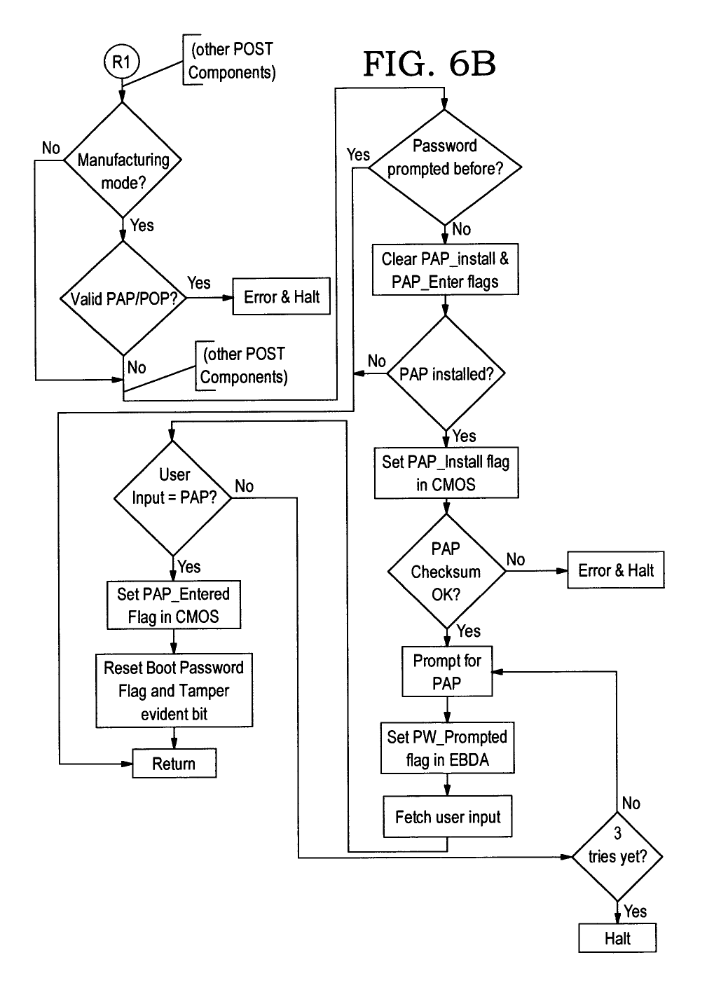

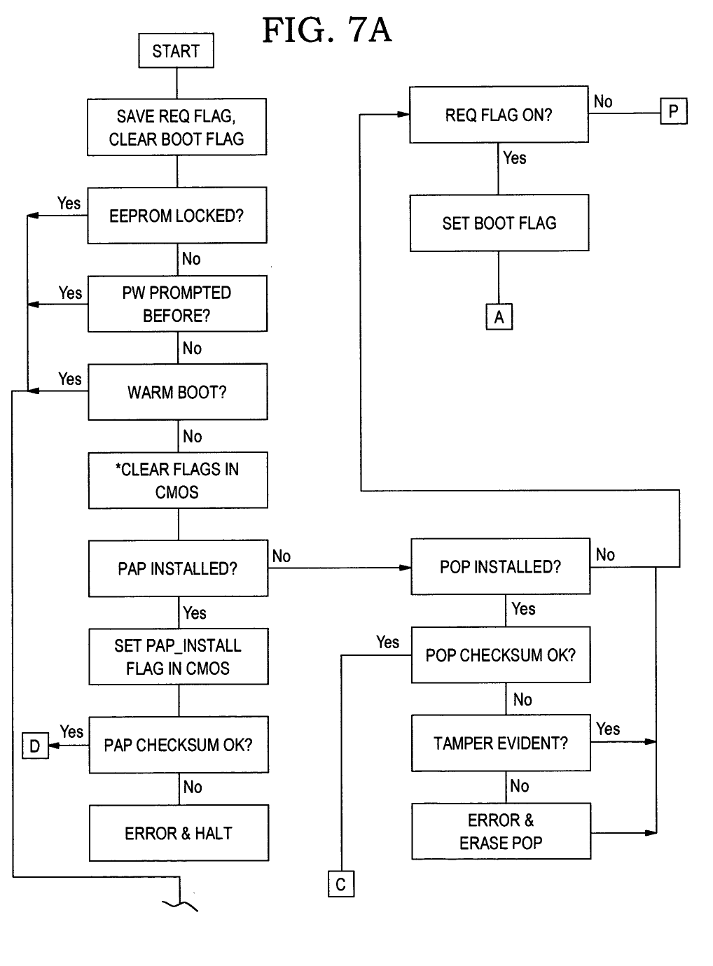

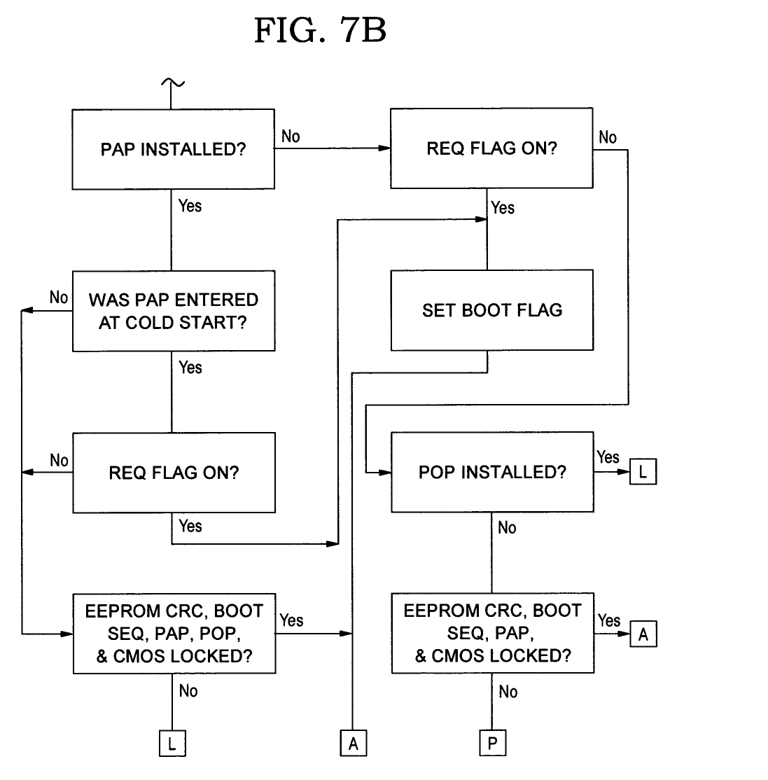

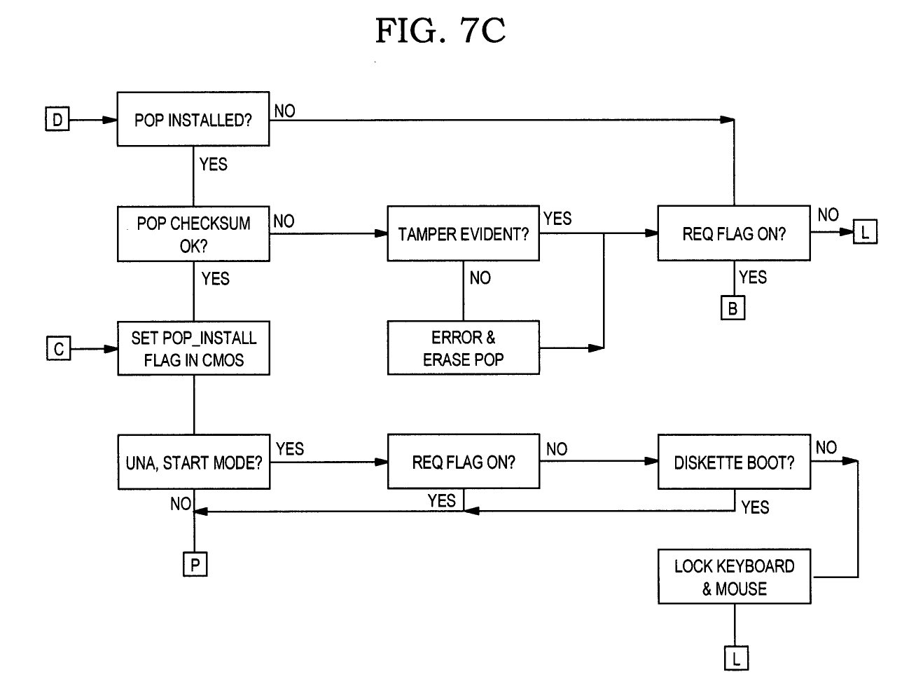

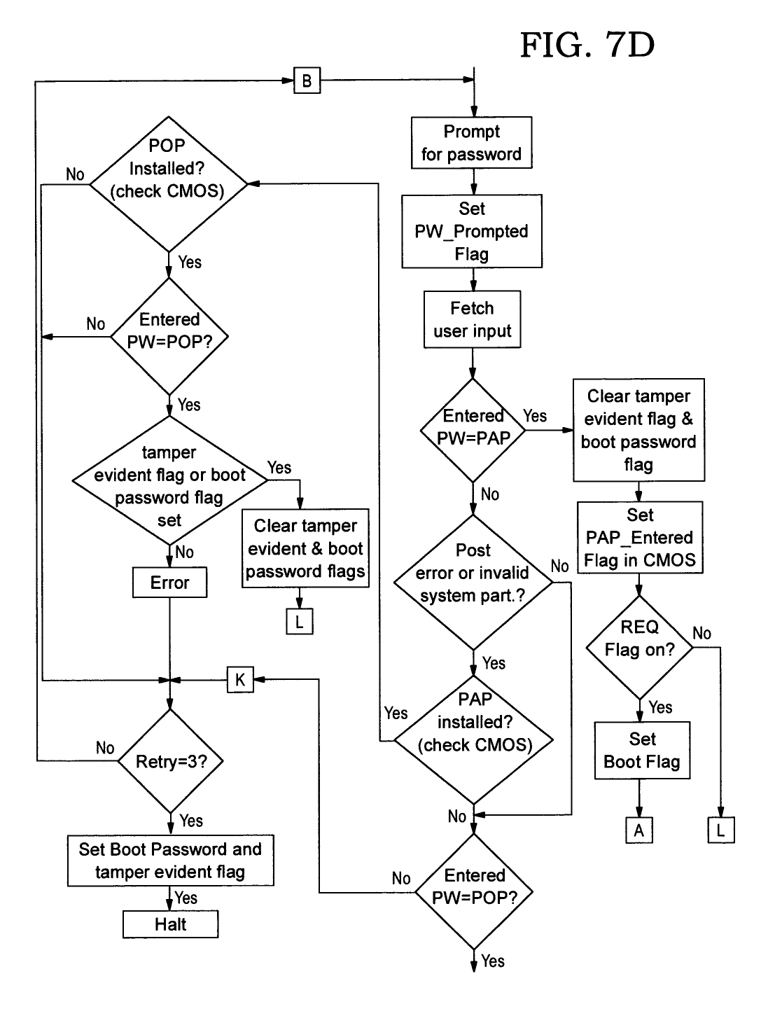

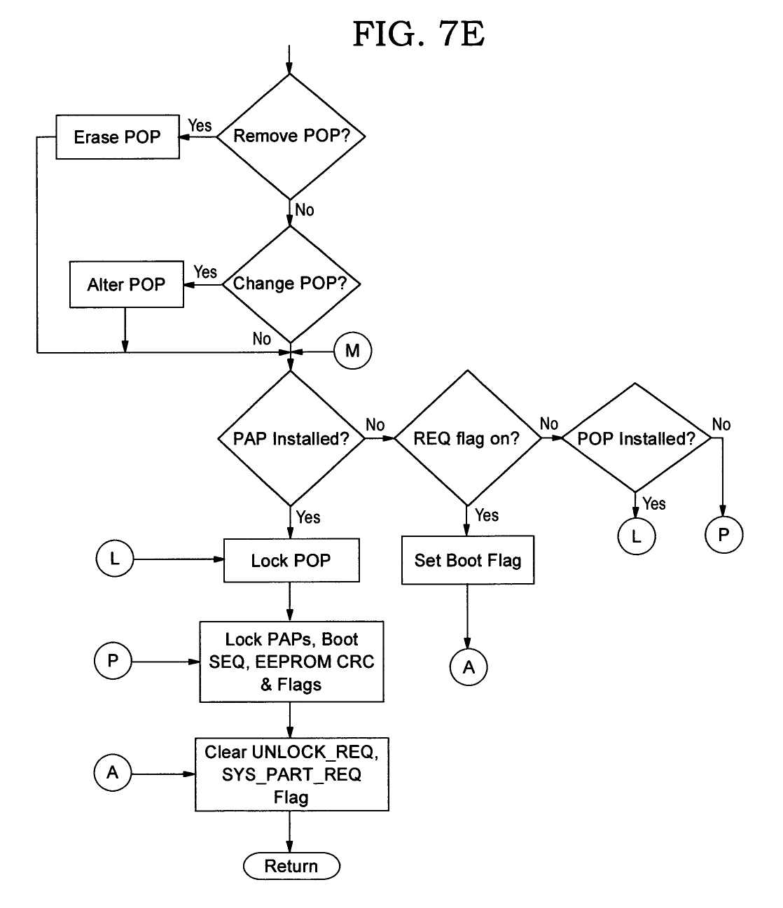

When triggered, detector 28 creates an ALARM signal by setting a one bit boot password flag in a register 130 (see FIG. 5) to the “ON” state. As will be described below with respect to FIGS. 6-7, this flag is tested by the boot logic in the setup sequence of computer 10 and, when the flag is in the “ON” state, the boot logic will require a password input to enable the operation of computer system 10. For example, when the flag is in the “ON” state, the boot logic will require a certain password before allowing the operating system (OS) to boot.

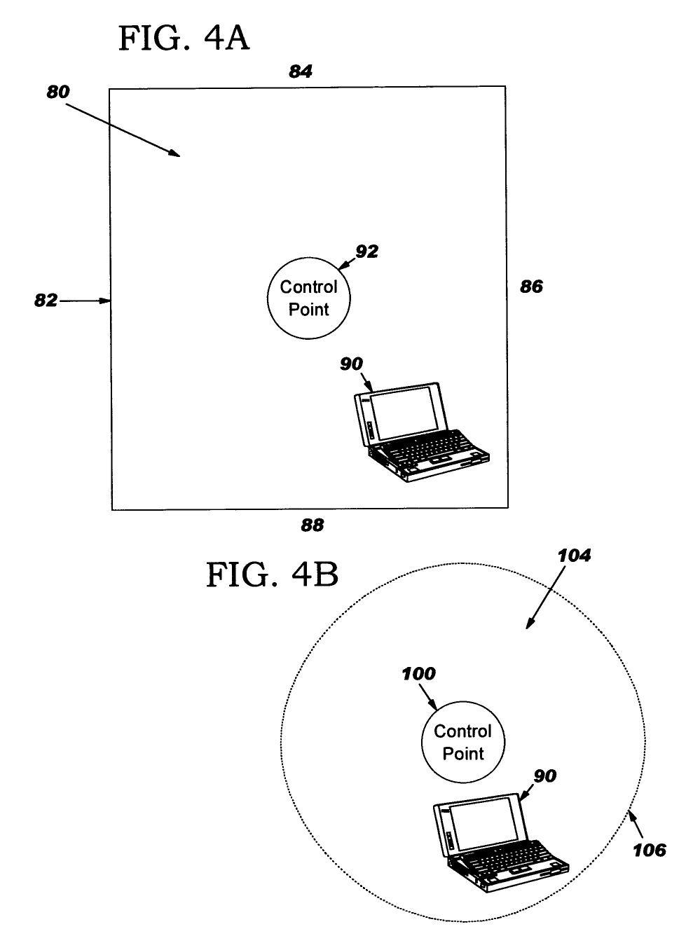

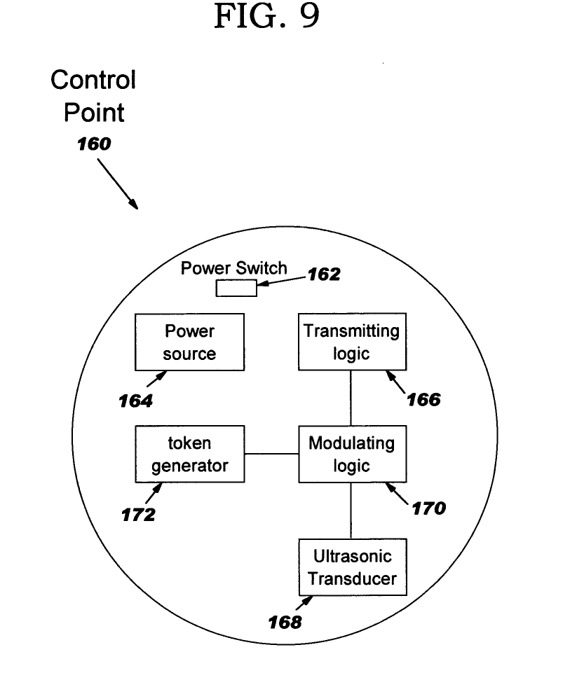

In another, but more complex embodiment of the invention, there is provided a first token generator and modulation logic in the control points 92 and 100 (see FIGS. 4A and 4B) and a second token generator 70 and demodulation logic 75 in the computer 90. Prior to transmission in a controlled area, the ultrasonic signal is modulated at the control point 160 (see FIG. 9) with a token generated by the token generator 172, such as the RSA SecurID Hardware Token, RSA SecurID Key Fob (SD600), adopted to be used and incorporated into a computer or other similar electronic device. The two token generators 70 and 172 are in time synchronization such that the tokens generated by the individual token generators 70 and 172 are identical in value at the same instance of time. This will be referred to as a matched pair of token generators. The demodulation logic 75 recognizes and removes the modulated data from the modulated ultrasonic signal and the boot logic compares the token received to the token generated by the local token generator 70 in the protected computer system 90. If they are equal, the boot logic continues execution and prepares computer system 90 to boot the OS. If the tokens are not equal, the boot logic prevents the boot operation from completing and prompts for entry of a password to become operative.

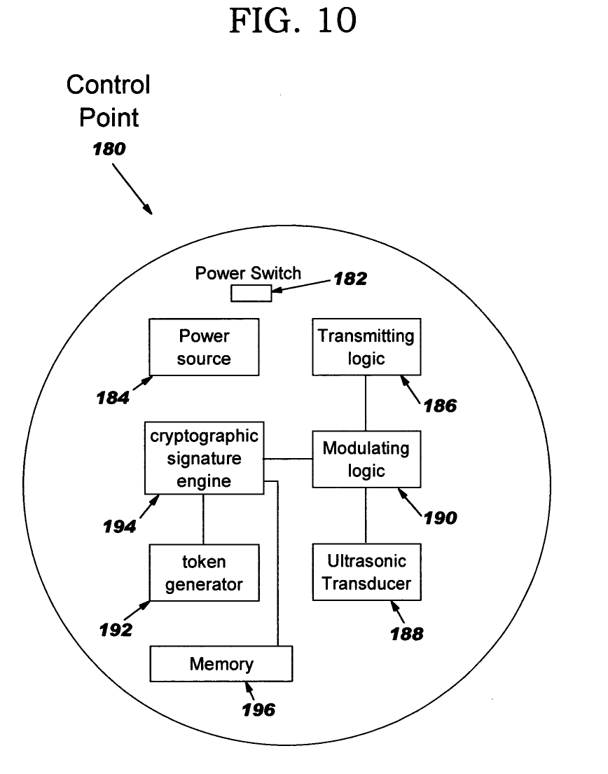

In another, but far more complex embodiment, the token generated at the control point 180 (see FIG. 10) is digitally signed using a first digital cryptographic signature engine 194 (prior to modulating the ultrasonic signal) using the cryptographic private key of the control point 180 and the cryptographic public key of the protected computer system 90. Such digital cryptographic signature engines are known in the art; for example, the IBM Embedded Security Subsystem used in the IBM NetVista® and Thinkpad® Products may be used. At the receiving computer 90 (a protected unit), the demodulation logic 75 must decode the transmitted encrypted token, decrypt it using the local cryptographic private key of the computer system 90 and the cryptographic public key of the control point 180. The decrypted token is compared by the boot logic to the token generated by the second token generator 70 resident in computer system 90. If they are equal, the boot logic in computer 90 boots the OS. If they are not equal, the boot logic prevents the boot operation from completing and prompts for entry of a password.

FIG. 3 is a block diagram of computer system 10 illustrating the various components of the system including components mounted on the planar 20, the connection of the planar to the I/O slots 64 and other system hardware. Prior to relating the above structure to the boot logic of the computer, a summary of the general operation of computer system 10 will be presented. Referring to FIG. 3, system processor or “CPU” 50 is connected to planar 20. While any appropriate microprocessor can be used as processor 50, one suitable microprocessor is the Pentium 4, which is sold by Intel. CPU 50 is connected by a high speed system bus 72 to a memory controller hub (MCH) 52. Bus 72 is also referred to as the “front side system bus.” In this instance, the MCH 52 also contains a graphic function; hence, the chip is known as a graphic memory controller hub (GMCH) 52, and it is commonly referred to as the “North Bridge” in the current architecture used in the personal computing industry.

CPU 50 is connected to memory 58, a graphic connector known as AGP 62 and the I/O Controller Hub (ICH) 54 through GMCH 52. Memory 58 may consist of SDRAM, DDR or RDRAM memory modules as defined by the appropriate standards related to the particular memory technology being utilized and are well known in the art. GMCH 52 is connected to I/O Controller Hub (ICH) 54 via a hub architecture bus 76 defined by the manufacturer of the GMCH 52 and ICH 54 chipset. ICH 54 is sometimes referred to as the “South Bridge.” ICH 54 provides access to the standard computer system peripherals for CPU 50 and GMCH 52. Standard peripherals include, but are not limited to, IDE hard file 60, Analog Codec 66 and other “legacy” devices 67 such as a diskette drive, serial port, parallel port, PS/2 keyboard and PS/2 mouse, as is well known in the art. In addition, ICH 54 provides access to Firmware Hub (FSH) 56, Cryptographic signature engine 68, token generator 70, non-volatile memory (EEPROM) 71 and a combined ultrasonic signal detector and demodulation logic 75.

FSH 56 contains the BIOS code in which is stored program instructions for basic input/output operations to CPU 50 as is well understood in the art. The BIOS code includes the run time BIOS interface that is used to interface between I/O devices and the OS for CPU 50. The BIOS code also includes boot code, which is used to initialize or prepare computer system 10 for booting the OS. The BIOS instructions stored in FSH 56 can be copied to memory 58 for execution by processor 50 in order to decrease the execution time of BIOS. Computer system 10 also has a circuit component which has battery backed non-volatile memory for receiving and retaining data regarding the system configuration and a real-time clock 69 commonly referred to as the RTC. RTC 69 may be embedded in a Super I/O (SIO) module 65 or it may be a discrete component (not shown).

While the present invention is described hereinafter with particular reference to the system block diagram of FIG. 3, it is to be understood at the outset of the description which follows that is it contemplated that the apparatus and methods in accordance with present invention may be used with other hardware configurations of the planar board. For example, SIO 65, which provides access to many of the legacy devices 67 attached to a personal computer, may be implemented using discrete components, or the IDE hard file 60 may be replaced by a Small Computer Systems Interface (SCSI) adapter and a SCSI hard file as is well know in the art.

Returning now to FIG. 3, ICH 54 also provides access to I/O slots 64, which are coupled to the ICH using the well known PCI bus 78. The number of I/O slots 64 may vary and depends on the technology presently available and the loading characteristics of the PCI bus 78. Additional slots 64 may be provided by implementing a PCI-to-PCI Bridge as is known in the art. Also, System Management Bus (SMBus) 74 couples ICH 54 to Cryptographic signature engine 68 and token generator 70. Both the signature engine 68 and token generator 70 play a part in the security provisions described hereinafter. Also, attached to SMBus 74 is an Electrical Erasable Programmable Read Only Memory (EEPROM) 71 for storing passwords used by the present invention, and an ultrasonic detector and demodulation logic 75 detector and demodulation logic 75 contains a register 73 for providing access to any data found encoded in the ultrasonic signal.

In addition, attached to ICH 54 are industry standard Universal Serial Bus (USB) ports 77. USB ports 77 facilitate the attachment of USB devices such as keyboards, pointing devices, printers, scanners and many others peripheral as defined in the industry by the USB specification available from the USB organization at www.usb.org. USB ports 77 may be compliant with either version 1.1 of the USB specification or version 2.0. CPU 50 has access to the attached USB devices via ICH 54. ICH 54 is also attached to the Super Input/Output (SIO) 65 module. SIO 65 provides the necessary interface to CPU 50 to access the well known legacy devices 67, such as the NEC compatible diskette drive, serial port, parallel port, PS/2 attached pointing devices or mouse, and PS/2 attached keyboard. Also, embedded in the SIO 65 is the RTC 69 function.

FIGS. 4A and 4B are pictorial diagrams of two versions of the security system of the present invention. Referring to FIG. 4A, the controlled area 80 is defined by the area bounded by the walls or partitions 82, 84, 86 and 88 of an office or other room. Controlled area 80 is flooded with an ultrasonic signal with a predefined characteristic above a pre-specified threshold value. It is envisioned that controlled area 80 can be another shape such as a hexagon or a circle and still benefit from the present invention. Due to the physics involved, ultrasonic signals will not penetrate the walls 82, 84, 86 and 88 and controlled area 80 will be referred to as a “bounded controlled area.” The protected unit 10 illustrated inside controlled area 80 of FIG. 4 is a mobile personal computer 90. However, it is envisioned that other devices such as a desktop personal computer or a PDA can be used in the present invention and receive the same protection benefits. Control point 92 contains an ultrasonic transmitter which transmits the specified ultrasonic signal to adequately flood controlled area 80 with ultrasonic signals at or above a certain threshold to provide the necessary protection for the present invention. Control point 92 does not have to be located in the center of the controlled area as long as it provides adequate coverage throughout the entire controlled area 80, nor does it need to be fixed to a non-removable item such as a wall or ceiling.

FIG. 4B illustrates an alternate controlled area 104. Referring to this figure, controlled area 104 is surrounded by boundary 106, which is designated by a dashed line as a physical boundary is not visible. In this instance, controlled area 104 will be defined by the area in which the receiver 30 can detect the ultrasonic signal above a certain threshold. A benefit is that the entity deploying such a boundless controlled area can choose the size of the area by varying the amplitude or signal strength of the ultrasonic transmitter and the sensitivity of the receiver 30 and detector 28. The boundary will be approximately circular shaped, but may vary depending on the characteristics of the ultrasonic transmitter at control point 100. The protected unit 90 is shown inside controlled area 104.

FIG. 5 is a schematic diagram of the security logic of the protected unit 10 of the present invention. Ultrasonic receiver 30 (such as a microphone) is positioned optimally to receive ultrasonic signals transmitted in controlled area 80 or 104. Ultrasonic receiver 30 uses technology known to those skilled in the art, such as a piezoelectric material to transform acoustic ultrasound waves transmitted from control point 92 or 100 into a received electrical signal. The received signal is coupled to a Detector 28 having an ALARM signal output, which is a LO voltage when ultrasonic signals are present and a HI voltage when ultrasonic signals are not present (the later being an indication that the protected unit is not in controlled area 80 or 104).

In accordance with the present invention, ultrasonic receiver 30 is connected through transistors 124 and 126, which respond to the ALARM signal to set the boot password flag at register 130, provided that EN_UDCT is enabled (HI). Preferably, register 130 is a segment of the CMOS RAM and Real Time Clock 62. The two transistors 124 and 126 (and the following inverter circuit) function as an AND gate and have the effect of setting register 130 to a distinctive state (such as all “1”s) if the transmission of ultrasonic energy is not detected, as upon the unauthorized removal of protected unit 90 from controlled area 80 or 104. Setting register 130 to a distinctive state will result in a configuration error signal being generated, which will alert a system owner that an attempt (successful or otherwise) has been made to breach system security. The polling loop logic for testing register 130 is shown in FIGS. 6 and 7. This signal, which is stored at register 130, is tested by the security logic contained in the boot logic as will be described more specifically with reference to FIGS. 6 and 7 and, if the register has been set, it will require entry of a correct password to complete the boot up sequence (see the diagrammatic representation of this logic at FIGS. 6 and 7).

The security and integrity feature described above and hereinafter work independently of a previously offered personal computer security feature, the Power On Password (POP). The password required to complete the boot up sequence if the alarm signal of the present invention has been activated is the Privileged Access Password (PAP) of the prior art patent, U.S. Pat. No. 5,388,156. The POP and PAP are treated as described in the prior art '156 patent in column 9 starting at line 48 and ending in column 12 at line 54, and are hereby incorporated by reference and well understood by those skilled in the art. The patent herein referenced has been selected merely as being exemplary. Flowchart logic for the scenarios just incorporated are included within FIGS. 6a-6c and 7a-7e, where links between certain steps are indicated by process blocks occupied by single letter designations in order to simplify the charting.

Referring once again to FIG. 5, connection of battery (“HI”) voltage or ground (“LO”) potential to the RTC 62 depends upon the state of the field effect transistors 124 and 126. When transistor 124 is OFF, the security feature is not enabled, and a HI voltage is always applied to inverter 125 through resistor R1, such that the input to register 130 is a LO voltage. When the system owner enables the security feature (EN_UDCT=HI) transistor 124 is turned “ON” by the EN_UDCT signal applied to the gate of transistor 124. When ultrasonic receiver 30 is in control zone 80 or 104 wherein the ultrasonic signal is being transmitted, ultrasonic detector 28 outputs a LO voltage signal to the gate of transistor 126, thereby switching transistor 126 OFF, which causes a HI voltage to be applied to the input of inverter 125 which, in turn, applies a LO voltage to the input of register 130 (similar to the security feature not being enabled). However, if ultrasonic signals with the first characteristic are not present, and with transistor 124 also switched ON (security feature enabled), the ALARM output of detector 28 goes HI, which switches transistor 126 ON, thereby pulling the input of inverter 125 LO which, in turn, outputs a HI voltage to the input of register 130 to set the boot password flag.

During a power-off to a powered-on state transition of the protected computer system 90, the boot code of the computer system 90 accesses and determines whether or not the boot password flag has been set to logical “1” and, if so, prompts for a PAP password. The boot logic then only reestablishes system operation upon the successful entry of the PAP; i.e., boot logic continues start-up operations by initializing the computer system, loading an OS from a pre-specified boot device into memory 58, and booting the operating system once resident in memory.

At the next power-up from a power-off state, the boot code will check to see if ultrasonic signal detection is enabled and if the detection mechanism has been activated. If both conditions are met, the boot code will prompt for the PAP. After three attempts of incorrectly entering the PAP, the boot code will disable the system. In order to reactivate the system, it is necessary to power the system OFF and then to power it back ON to obtain the prompt for the PAP. Until the PAP is correctly entered, the system will not boot and, thus, renders the system inactive after three unsuccessful attempts at correctly entering the PAP in a single power-on session. A power-off followed by a power-on cycle is required is required prior to being allowed to enter the PAP once-again. If this condition exists, it requires that the user return the system to either the system owner or an authorized user to be re-activated unless the user has knowledge of the PAP.

The systems which include the capability to detect ultrasound signals with a predefined characteristic have a register 130 set upon detection of the loss of ultrasonic signals. The power-on logic tests this register 130 to determine if security has been breached. If so, the normal power-on sequence is diverted but can be resumed, in a preferred implementation, by entering a correct password. Otherwise, the sequence is halted.

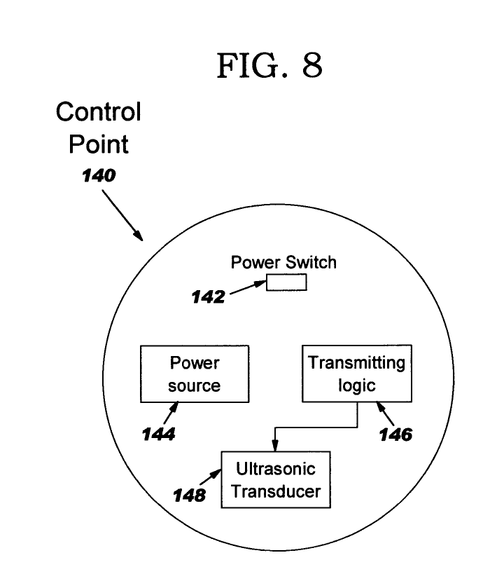

FIG. 8 is a pictorial diagram of control points 92 or 100 of controlled areas of zones 80 or 104 of the present invention. Control point 140 contains a power source 144, which may be a typical personal computer power supply requiring AC power from an electric utility power outlet (not illustrated) or ir may be a battery. Power source 144 is used to power all logic of the present invention found within the control point.

Operatively connected to the power source is a power switch 142. Power switch 142 is used to apply power to the components of control point 140, or to remove power from the components of the control point. If the system administrator of controlled area 80 or 104 decides to disable all protected units in controlled area 80 or 104, then all that is necessary is to shut down all ultrasonic transmissions using power switch 142.

It is envisioned that, in one embodiment, control point 140 is small in size and portable for use in a temporary office or living space to set up a temporary controlled area 80 or 104 in order to provide protection when a personal computer is not resident at its home location. Transmitting logic 146 is used to generate the ultrasonic signal with distinct characteristics. The ultrasonic transducer 148 is operatively coupled to the transmitting logic 146 for changing electrical energy into ultrasonic signals. An example of an ultrasonic transducer 148 is a piezo-electric buzzer or speaker. It is envisioned that the control point could be something as small as a handheld PDA, or it may be implemented using a industry standard personal computer with a PCI device adapter for providing the control point logic.

In another embodiment of control point 92 or 100, modulating logic 170 and token generator 172 are added to the logic of control point 140 to define control point 160. Power switch 162, power source 164, transmitting logic 166 and ultrasonic transducer 168 function similarly to their respective components in control point 140; for example, power switch 162 provides the same function as power switch 142 in control point 140. Token generator 172 is used to generate a token (a random value or number) which is used as data to modulate the ultrasonic signal with a distinct characteristic produced by transmitting logic 166. The output of modulating logic 170 is sent to ultrasonic transducer 168 for transmission within the controlled area 80 or 104.

In yet another embodiment of control point 92 or 100, cryptographic signature engine 194 and memory 196 are added to the logic of control point 160 to define control point 180. Power switch 182, power source 184, transmitting logic 186, ultrasonic transducer 188 and token generator 192 function similarly to their respective components in control point 160; for example, power switch 182 and power switch 162 function the same in the two control points 140 and 160. Token generator 192 is used to generate a token. The token is then encrypted or digitally signed by cryptographic signature engine 194 using control point's 180 private key (stored within engine 194) and the computer system's 90 public key (stored in memory 196). The signature is used as data to modulate the ultrasonic signal with a distinct characteristic produced by transmitting logic 186. The output of modulating logic 190 is sent to ultrasonic transducer 188 for transmission within controlled area 80 or 104.

Once enabled by a system administrator or other person with knowledge of the PAP, a protected computer system 90 of the present invention must remain within perimeter 82, 84, 86 and 88, or 106 of controlled area 80 or 104 as defined by control point 92 or 100, respectively. The system administrator uses a setup utility resident in the protected computer system 90 to enable the security feature of the present invention. The administrator will be required to enter a valid PAP in order to enable this security feature. Removal from the controlled area will cause the ultrasonic receiver 30 and ultrasonic detector 28 to detect loss of the signal and set the boot password flag in register 130 of the RTC 69.

The operation of the secured system of the present invention will now be described in relation to control points 140, 160 and 180 of FIGS. 8, 9 and 10, respectively, used in either of controlled areas 80 or 104.

Using the first control point 140, the secured system operates as described below. Upon transition from a powered-off state to a powered-on state, the boot logic of the protected computer system 90 is accessed and executed by CPU 50 in order to initialize and prepare the computer system 90 for booting the operating system. Security logic included in the boot logic checks the state of the boot password flag in register 130 in the RTC 69. If the boot password flag is found to be a “1” indicating that loss of ultrasonic signal was detected, the system causes the security logic to prompt for entry of a password. In this case, the security logic will only accept correct entry of a PAP. The POP will not be accepted in this situation and entry of a valid POP will be considered an invalid attempt at entering the PAP. As previously explained above, only three attempts are allowed by the boot logic prior to shutting down the system. This function of computer system 90 deters use of the system's security logic to repetitively “hammer” the password in an attempt to prevent an unauthorized user to take advantage of the security logic to breech the integrity of the password. Unless a valid PAP is entered, the security logic will not allow the boot logic to proceed with further preparations of the system in order to boot the designated operating system, thereby blocking usage of computer system 90. It is envisioned that computer system 90 can be implemented wherein the security feature of the present invention is enabled at all times, and the computer system does not provide a control option in setup to disable the security feature.

If enabled, a second configuration option will allow the administrator to set an option that will allow the boot logic to proceed to booting the OS without entering the PAP only if the protected computer system 90 is returned to a controlled area. The boot logic will erase or reset the boot password flag to a “0” or OFF state if this option is enabled and the protected computer system 90 is returned undamaged to a controlled area 80 or 104.

A more complex embodiment uses control point 160 of FIG. 9 and the corresponding logic in the protected computer system 90 such as token generator 172. Using the control point 160, the secured system operates as described below.

Upon transition from a powered-off state to a powered-on state, the boot logic of the protected computer system 90 is accessed and executed by 50 in order to initialize and prepare the computer system 90 for booting the operating system. Security logic included in the boot logic checks the state of the boot password flag in register 130 in RTC 69. If found to be a “1” indicating that loss of ultrasonic signal was detected, the system causes the security logic to prompt for entry of a password. In this case, the security logic will only accept correct entry of a PAP. If the boot password flag in register 130 is not set (i.e., a “0”) then the ultrasonic detector 28 is detecting ultrasonic signals with the distinct characteristic. The security logic of the protected computer system 90 will access the token that was used to modulate the ultrasonic signals of controlled area 80 or 104. The security logic will also read a token from the local token generator 70 on planar 20 or adapter card 64. The token received from control point 160 and decoded from the ultrasonic signals is read from register 73 of the ultrasonic detector and demodulator logic 75 and is then compared to the value read from the local token generator 70. The token generator 172 in control point 160 and the local token generator 70 are in time synchronization as previously explained above. If the received token and locally produced token are found not to be equal in value, the security logic will prompt for the entry of a password. In this case, the security logic will only accept correct entry of a PAP. The POP will not be accepted in this situation and entry of a valid POP will be considered an invalid attempt at entering the PAP. As previously explained above, only three attempts are allowed by the boot logic prior to shutting down the system. This function of protected computer system 90 deters use of the system's security logic to repetitively “hammer” the password in an attempt to prevent an unauthorized user to take advantage of the security logic to breech the integrity of the password. Unless a valid PAP is entered, the security logic will not allow the boot logic to proceed with further preparations of the system in order to boot the designated OS, thereby blocking usage of protected unit 90. It is envisioned that a protected device can be implemented wherein the security feature of the present invention is enabled at all times, and the protected unit does not provide a control option in setup to disable the security feature.

If enabled, a second configuration option will allow the administrator to set an option that will allow the boot logic to proceed to boot the OS without entering the PAP only if protected computer system 90 is returned to a controlled area 80 or 104 with the matching (time synchronized) token generators. The boot logic will erase or reset the boot password flag to a “0” or OFF state if this option is enabled and the computer system 90 is returned undamaged to the controlled area 80 or 104.

A far more complex embodiment uses control point 180 of FIG. 10 and the corresponding logic in the protected unit 90 such as token generator 192 and cryptographic signature engine 194. Using control point 180, the secured system operates as described below.

Upon transition from a powered-off state to a powered-on state, the boot logic of protected computer system 90 is accessed and executed by CPU 50 in order to initialize and prepare the computer system 90 to boot the operating system OS. Security logic included in the boot logic checks the state of the boot password flag in register 130 in RTC 69. If the boot password flag is found to be a “1” indicating that loss of ultrasonic signal was detected, the system causes the security logic to prompt for entry of a password. In this case, the security logic will only accept correct entry of a PAP. If the boot password flag in register 130 is not set (i.e., a logical “0”), then ultrasonic detector 28 is detecting ultrasonic signals with the distinct characteristic. In this case, the security logic will access the digitally signed or encrypted token that was used to modulate the ultrasonic signals of controlled area 80 or 104. The security logic will also read a token from the local token generator 70 on planar 20 or adapter card 64. The encrypted or signed token received from control point 180 is read from register 73 of the ultrasonic detector and demodulator logic 75. It is then decrypted using the private cryptographic key of the control point 180 stored in non-volatile memory in the protected unit 90 and is then compared to the value read from the local token generator 70. The token generator 192 in control point 180 and local token generator 70 in the protected computer system are in time synchronization as previously explained above. If the received token and local token are found not to be equal in value, the security logic will only accept correct entry of a PAP. The POP will not be accepted in this situation and entry of a valid POP will be considered an invalid attempt at entering the PAP. As previously explained above, only three attempts are allowed by the boot logic prior to shutting down the system.

This function of protected computer system 90 deters use of the system's security logic to repetitively “hammer” the password in an attempt to prevent an unauthorized user to take advantage of the security logic to breech the integrity of the password. Unless a valid PAP is entered, the security logic will not allow the boot logic to proceed with further preparations of the system in order to boot the designated OS, thereby blocking usage of the protected unit. It is envisioned that a protected device can be implemented wherein the security feature of the present invention is enabled at all times, and the protected unit does not provide a option in setup to disable the security feature.

If enabled, a second configuration option will allow the administrator to set an option that will allow the boot logic to proceed to booting the operating system without entering the PAP only if the protected computer system 90 is returned to a controlled area with the matching token generator and cryptographic signature engine 68. The boot logic will erase or reset the boot password flag to a logical “0” or OFF state if this option is enabled and the token generators are a matching pair and the control point's public key stored in protected unit 90 matches the public key belonging to control point 180 with controlled area 80 or 104 when the protected computer system 90 is returned.

The instant invention has been shown and described herein in what is considered to be the most practical and preferred embodiments. It is recognized, however, that departures may be made therefrom that are within the scope of the invention, and that obvious modifications will occur to a person skilled in the art that are within the scope and spirit of the claimed invention. For example, the distinctive characteristic of the ultrasonic signals used in the controlled area may be frequency itself, or may be a preferred pattern on a carrier frequency.

We claim as our invention:

1. A secure system, comprising:
a control unit having an ultrasonic transmitter for transmitting, within a controlled area, ultrasonic signals having a distinctive characteristic; and
a protected unit, comprising:
an operating system;
a first password stored in said protected unit;
means for entering a second password;
a password flag having logical “0” and “1” states;
an ultrasonic receiver for receiving the ultrasonic signals transmitted by said control unit;
detection logic operatively coupled to said ultrasonic receiver for setting the password flag to a logical “1” state in response to the loss of the ultrasonic signal as received by said ultrasonic receiver; and
boot code executable by said protected unit, wherein said boot code checks the logical state of said password flag and then performs one of the following functions depending on the logical state of said password flag:
if said password flag is in a logical “0” state, said boot code causes said operating system to boot, thereby enabling the normal operation of said protected unit;
if said password flag is in the logical “1” state, said boot code requests the entry of a second password and, in response to the entry of a second password identical to the first password as stored in said protected unit, said boot code causes said operating system to boot, thereby enabling the normal operation of said protected unit; however, in response to a second password different from the first password as stored in said protected unit, said boot code inhibits the booting of the operating system, thereby disabling the normal operation of said protected unit.
whereby, when the protected unit is removed from the controlled area, thereby causing the loss of the ultrasonic signal as received by said ultrasonic receiver, a second password must be entered that is identical to the first password stored in said protected unit to permit the operating system to boot, thereby enabling the normal operation of the protected unit.

2. The secure system of claim 1, wherein the distinctive characteristic is the frequency of the ultrasonic signals as transmitted by said control unit.

3. The secure system of claim 1, wherein the distinctive characteristic is a predetermined digital code modulated onto the ultrasonic signals as transmitted by said control unit.

4. The secure system of claim 1, wherein the distinctive characteristic is an analog audio signal modulated onto the ultrasonic signals as transmitted by said control unit.

5. A protected unit for use with a control unit having an ultrasonic transmitter for transmitting, within a controlled area, ultrasonic signals having a distinctive characteristic, said protected unit comprising:
an operating system;
a first password stored in said protected unit;
means for entering a second password;
a password flag having logical “0” and “1” states;
an ultrasonic receiver for receiving the ultrasonic signals transmitted by the control unit;
detection logic operatively coupled to said ultrasonic receiver for setting the password flag to a logical “1” state in response to the loss of the ultrasonic signal as received by said ultrasonic receiver; and
boot code executable by said protected unit, wherein said boot code checks the logical state of said password flag and then performs one of the following functions depending on the logical state of said password flag:
if said password flag is in a logical “0” state, said boot code causes said operating system to boot, thereby enabling the normal operation of said protected unit;
if said password flag is in the logical “1” state, said boot code requests the entry of a second password and, in response to the entry of a second password identical to the first password as stored in said protected unit, said boot code causes said operating system to boot, thereby enabling the normal operation of said protected unit; however, in response to a second password different from the first password as stored in said protected unit, said boot code inhibits the booting of the operating system, thereby disabling the normal operation of said protected unit.
whereby, when the protected unit is removed from the controlled area, thereby causing the loss of the ultrasonic signal as received by said ultrasonic receiver, a second password must be entered that is identical to the first password stored in said protected unit to permit the operating system to boot, thereby enabling the normal operation of the protected unit.

6. The secure system of claim 5, wherein the distinctive characteristic is the frequency of the ultrasonic signals as transmitted by said control unit.

7. The secure system of claim 5, wherein the distinctive characteristic is a predetermined digital code modulated onto the ultrasonic signals as transmitted by said control unit.

8. The secure system of claim 5, wherein the distinctive characteristic is an analog audio signal modulated onto the ultrasonic signals as transmitted by said control unit.
